(19) United States
(12) Patent Application Publication
(10) Pub. No.: US 2017/0188754 A1
(43) Pub. Date: Jul. 6, 2017

(54) Technologies for Releasing Thermal Energy

(71) Applicant: Melissa Zimberg, Maplewood, NJ (US)

(72) Inventor: Melissa Zimberg, Maplewood, NJ (US)

(21) Appl. No.: 15/217,769

(22) Filed: Jul. 22, 2016

Related U.S. Application Data
(60) Provisional application No. 62/274,230, filed on Jan. 1, 2016.

(51) Int. Cl. A47J 39/00; B65D 81/38; A47J 47/14; C09K 5/06

(52) U.S. Cl. CPC A47J 39/00; C09K 5/063; B65D 81/3816; A47J 47/14

(57) ABSTRACT

A heat unit containing a phase change material consisting of polyethylene glycol and a fatty acid combination of stearic and palmitic acids is disclosed. When heated in a microwave for about four (4) minutes the heat unit reaches a temperature of about 70° C. (158° F.). When placed in an insulated container, the heat unit will, after six (6) hours, have a temperature of about 40° C.-55° C. (104° F.-131° F.). The heat unit is advantageous for maintaining food hot during transport as well as other uses where long term heat emission is needed.

### CROSS-REFERENCE TO RELATED APPLICATIONS

The present application claims the benefit of U.S. Provisional Patent Application Ser. No. 62/274,230 filed Jan. 1, 2016, which is incorporated herein by reference in its entirety for all purposes.

### BACKGROUND OF THE INVENTION

There are many areas where it is optimal to safely maintain food warm for several hours such as when traveling, working, or otherwise away from home. However, this has, theretofore, presented a problem in that prior art portable heating devices do not maintain heat for any length of time without reheating. For example, a child typically eats warm meals at lunchtime in school as provided by the school. However, when the child dislikes the meals or the child has allergies, the child's caretaker would need to send lunches to school. Since lunch boxes or carriers are usually insufficiently thermally insulated, any food to be served warm cools by the time the child eats lunch. Therefore, in order to maintain the food products warm until lunchtime, the caretakers resort to various methods. An alternative to the standard lunch box or bag, would be an insulated tote bag. Few tote bags, however, have sufficient thermal insulation and can only slow the cooling of the food, and are unable to provide thermal energy for maintaining the food products warm.

Another method is to use a thermos, however, many thermoses are inadequate due to their structure, which is usually cylindrical with a small food product access opening, thereby limiting the types of food that can be contained within. Further, the thermoses are inadequate due to their inability to provide thermal energy for maintaining the food products warm.

In an attempt to add radiating thermal energy gels or water-based heat packs can be used. More importantly, such heat packs do not provide adequate latent heat or thermal energy as to maintain temperature for a sufficient period of time. Such heat packs do not reach sufficient temperatures as to provide enough warmth to the food contained within the carrier to maintain it warm for a sufficient length of time. Further, such heat packs do not possess sufficient latent heat and expend their energy quickly and therefore do not provide heat for a sufficient period of time. Additionally, some gels and water based agents expand in volume when heated and resultantly, the gel or water based pack can burst and release the heated gel or water onto the heat source or the food products, which is a potential safety hazard or a food contamination hazard. Many gel or water-based heat packs cannot be heated directly in the microwave requiring the user to heat the pack within a container of water or to submerge the pack in boiling water. This poses both an inconvenience and safety risk as the water must reach very high temperatures in order to heat the pack. Microwavable hot or cold packs which are commercially available are gel or water-based and in liquid phase both at room temperature and after heating. Phase transition does not occur after microwave heating. Therefore, only sensible heat is used for any heating application which is 2-3 times less than Phase Change Material (PCM).

Form stable phase change materials, an example of which is disclosed in WO2014064518 A2, are very expensive, labor intensive to produce, and have lower latent heat than required for optimal results. Most at this temperature range use stearic acid as the basic phase change material, which has a high latent heat, but is subsequently reduced by percentage with the addition of the other ingredients that make it form-stable, resulting in a material with a lower latent heat.

Some containers, lunch totes or lunch boxes have at least one sidewall which contains a non-removable gel or water-based heat pack or a thermally retentive material. This design, however, presents its own set of problems since in order to heat the gel-based pack, the entire container must be placed into a heat source, such as an oven or a microwave, creating a risk of burning, melting, smoking, and/or singeing. Further, some gels heat unevenly in the heat source and can burn or melt the sidewall, while some gel or water-based heat packs expand in volume when heated and can burst thereby releasing the contents. Although not a safety issue, containers with non-removable heat packs cannot be adjusted thereby affecting the heating level. Since the heat pack is contained within the container, a barrier exists between the food and the heat pack, which effectively reduces thermal communication, allowing the food to cool faster. Unless there is sufficient thermal insulation in the outer wall of the container, heat is dispersed both inwardly and outwardly, rapidly exhausting the heat pack.

### SUMMARY OF THE INVENTION

A heat unit is disclosed having an outer container with at least two walls and containing a phase change material. Although the container can be flexible in most uses a rigid polyethylene container maintains heat longer. The phase change material changes from solid to liquid at a temperature of about 70° C. (158° F.) upon exposure to a heat source for a predetermined period of time and has a latent heat capacity of about 190 kj/kg. The disclosed phase change material consists of polyethylene glycol 8000 and a fatty acid combination of about 54% palmitic acid and about 45% stearic acid in a 3:1 ratio. The preferred method of heating is a 1200 watt residential microwave for about four (4) minutes. When placed in an insulated container, with a pre-heated food/water substance at ambient temperature, the temperature of the heat pack is about 46° C.-49° C. (114.8° F.-120.2° F.) after six hours in the insulated container. A substance (325 g water) heated to 71° C. (159.8° F.) is placed in the insulated container with the heat packs. After six (6) hours the substance is at about 50° C. (122° F.). The preferred insulation in the container is equivalent of at least 7 mm of polyurethane foam insulation.

The preferred heat unit container is manufactured from a rigid polypropylene and has gripping areas formed by two of the at least two walls in contact with one another to prevent heat transfer from the phase change material to an exterior surface of the container. The disclosed heat unit can be combined with a food carrier to enable food to be maintained hot for about six (6) hours.

To maintain food or other substance above a predetermined low temperature at least one heated heat unit is used in an insulated container. The food is heated to a temperature above a final temperature. The heat unit, each containing a phase change material having 3 parts polyethylene glycol and 1 part fatty acid combination consisting of about 54% palmitic acid and about 45% stearic acid is heated for about four (4) minutes in a microwave or other heating source. The heat packs are placed into the insulated container adjacent to the food and the container secured.

### BRIEF DESCRIPTION OF THE DRAWINGS

The accompanying drawings illustrate example embodiments of the present disclosure. Such drawings are not to be construed as necessarily limiting the disclosure. Like numbers and/or similar numbering scheme can refer to like and/or similar elements throughout.

FIG. 1 shows a front view of an example embodiment of a heating tote bag according to the present disclosure;

FIG. 2 shows a side view of an example embodiment of a heating tote bag according to the present disclosure;

FIG. 3 illustrates a face view of the heating unit according to the present disclosure;

FIG. 3A illustrates a side view of the heating unit of FIG. 3 according to the present disclosure;

FIG. 3B illustrates a face view of an alternative design of the heating unit according to the present disclosure;

FIG. 4 illustrates an alternative embodiment of a heating unit for use with the present disclosure;

FIG. 5 illustrated a side view of an alternate embodiment showing a hard shell tote according to the present disclosure; and

FIG. 6A-6D is a chart illustrating the testing sequence and results for the determination of the disclosed phase change material according to the present disclosure.

### DETAILED DESCRIPTION OF THE PREFERRED EMBODIMENTS

The present disclosure is now described more fully with reference to the accompanying drawings, in which example embodiments of the present disclosure are shown.

### Definitions

As used herein, the term “about” and/or “substantially” refers to a +/−10% variation from the nominal value/term. Such variation is always included in any given value/term provided herein, whether or not such variation is specifically referred thereto.

As used herein the term “Polyethylene glycol” and/or “PEG” will reference polyethylene glycol being expressed as H—(O—CH₂—CH₂)ₙ—OH. Any use of other expressions of PEG, such as polyethylene oxide (PEO) or polyoxyethylene (POE), will be specifically noted.

As used herein the term “latent heat” shall refer to the heat required to convert a solid into a liquid or vapor, or a liquid into a vapor, without a change of temperature or pressure.

As used herein the term “palmitic acid”, “C16” and “PA C16” shall all refer to the saturated fatty acid having the chemical formula of CH₃(CH₂)₁₄COOH and be used interchangeably herein.

As used herein the term “stearic acid”, “C18” and “SA C18” shall all refer to the saturated fatty acid having the chemical formula of CH₃(CH₂)₁₄COOH and be used interchangeably herein.

1. As used herein the term “fatty acid combination” shall refer to the combination of palmitic acid (C16) and stearic acid (C18) in a preferred ratio of C16:about 54%; C18:about 45%.

As used herein the terms “heat pack” “heating unit” and “heat unit” shall be used interchangeably and refer to an outer container containing the disclosed phase change material.

As used herein the term “phase change material” shall refer to a material with a high heat of fusion which, melting and solidifying at a certain temperature, is capable of storing and releasing large amounts of energy. The phase change material disclosed herein is a solid to liquid with liquidification being reached at about 70° C. (158° F.).

As used herein the term “broad spectrum of phase change” shall refer to the range of temperatures over which heat is emitted due to each material in the mixture having its own, individual, phase change temperature.

As used herein the term “disclosed PCM” shall refer to the phase change material comprising a 3:1 ratio of polyethylene glycol 8000 and a fatty acid combination consisting of about 54% C16 and about 45% C18.

Cold packs are commonly used in a variety of areas from food transport and service to medical treatments. Heat packs, however are more problematic and are generally heated only to mild temperatures and found primarily in flexible containers. As stated heretofore, the currently available heat packs do not solve the problem of long term heat emission and the higher heat required for food transport.

Phase change materials present a solution, however there is a void in currently available phase change materials with phase-change temperatures sufficient for warming food, and with latent heat value high enough for long term heat emission. Many phase change materials available at such temperatures cannot be produced efficiently and inexpensively, and as such they would not be suitable for use in consumer and industrial application to keep food temperatures sufficiently elevated. This can be because compounds that are extant in the natural world lack a suitable phase-change point, or their enthalpy variable tends to be too low, or that he materials and the associated production process renders them so expensive as to become unsuitable for such applications.

In organic substances, such as most salt hydrates, the phase change temperatures and/or latent heat are not sufficiently high enough for long term heating. Other problems that proved them as un-useable on their own are lack of congruent melting points, instability, short service lives, and sparking or arcing when microwaved. The organic materials tested, must also be mixed with another material. Alone there are issues with encapsulation, microwave reception, or insufficient latent heat at appropriate temperatures.

Other organic substances, such as hexadecane, are not cost effective due to separation costs to achieve the pure product. Commercially cost-effective paraffins are mixtures of alkanes and do not have well defined, consistent melting points. Additionally, some paraffins are toxic, making them unadvisable around food products and children. From an environmental standpoint, it can take pariffins decades to break down.

An insulated article incorporating a heating unit using the disclosed PCM as an energy-storing heating source can be employed to keep foods at a temperature or range of temperatures for a period of time of about four (4)-six (6) hours. Unlike a water based heat pack, the disclosed PCM uses a physical phase-change process to absorb or release a large quantity of latent heat in order to store energy, and therefore it is able to provide heat for a relatively long period of time.

The present disclosure combines materials, in ratios and molecular weights to produce a microwavable energy storing phase-change material that is easy and inexpensive to produce while providing long term heat emission. The disclosed PCM has a phase change point in the range of about 60° C.-80° C. (140° F.-176° F.) and preferably 65° C.-72° C. (149° F.-161.6° F.) and has a latent heat capacity of about 190 kj/kg or greater. Through the addition of two long chain fatty acids, palmitic C16 and stearic acid C18, in specific ratios, to PEG 8000 the melting point is raised from about 55° C. (131° F.) to about 70° C. (158° F.), an increase of about 25% from PEG8000 alone; and the latent heat capacity is raised from about 171 kj/kg to about 190-205 kj/kg, an increase of about 20%. The composite further enables the disclosed PCM to remain active over a broader range as the temperatures begins to fall, thus elongating the time period for which it radiates heat.

While other singular phase change materials can transition at similar temperatures, they are expensive, thereby reducing the situations in which they are applicable and have lower latent heat capacities thereby reducing the amount of heat and/or the time period for which they provide heat. It is through the disclosed combination of three phase change materials that a high temperature transition was achieved, with a broad spectrum phase change point, at a cost significantly lower than other methods of achieving similar temperatures.

The disclosed composite provides a high melting point incorporating a broad spectrum of phase change, high latent heat capacity and the ability to withstand heating over multiple uses. Further, the composite does not spark or arc within a microwave. The combination of properties provides the disclosed phase change material with characteristics ideally suited for use in food transportation items intended for consumer use where higher temperatures or greater safety considerations are required.

It should be noted that for illustration in the disclosed a lunch tote and box are illustrated, however this does not limit the uses of the disclosed heating units. Additional uses, in either hard shell or flexible containers, can be used to emit heat in clothing, such as ear muffs, neck warmers, hats; carriers, such as diaper bags, food service; or medical, such as pre-surgery warmers, chiropractic; to name a few. Any use where a compact, independent, heat source is desired, the disclosed PCM can be used. Other uses for the disclosed PCM composite will be evident to those skilled in the applicable arts.

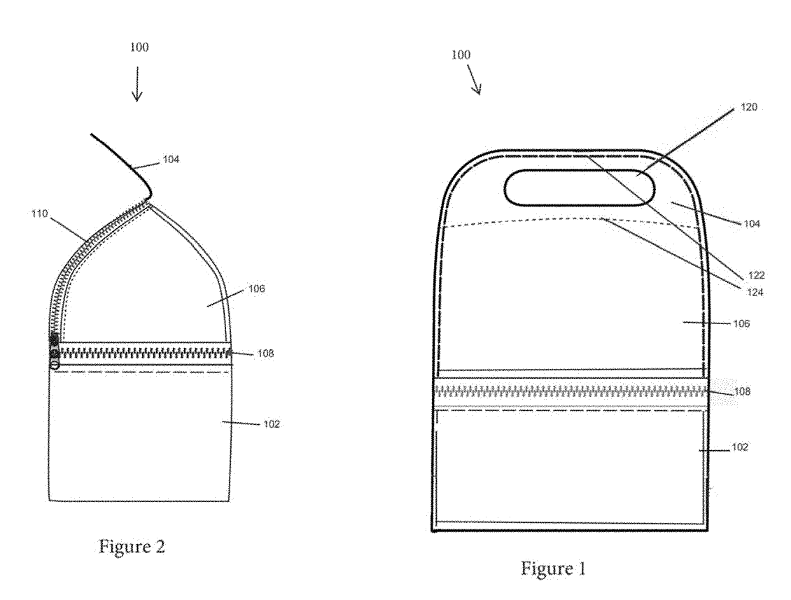

FIGS. 1 and 2 illustrate an example of a heating tote bag 100 for use with the disclosed thermal heating element. The heating tote bag 100 includes a lower containing unit 102, and upper containing unit 106 and a handle unit 104 upwardly extending from the upper containing unit 106. The upper containing unit 106 and the handle unit 104 are generally affixed to one another via stitching, but other suitable assembly methods can be used based on size and materials of manufacture. Alternatively one side of the upper containing unit 106 and the handle unit 104 can be unitary with each other. Also, note that, in yet other embodiments, various types of handheld/wearable containers are used, such as a schoolbag, a suitcase, a laptop bag, a briefcase, a hiking backpack, catering food container, food delivery bag or container, and other suitable containers.

In the illustrated example the lower containing unit 102 and upper containing unit 106 are soft sided cuboid, but other suitable shapes and material hardness can be used and are dependent upon manufacturing preferences and end use. The lower containing unit 102 is an assembly of a base and a plurality of sidewalls upwardly extending from the base, the assembly of which is dependent upon material of manufacture and end use.

The lower containing unit 102 is releasably connected to the upper containing unit 106 on at least three (3) sides by a securing member 108 such as a zipper, snaps, Velcro, suitable for the material of manufacture. In the illustrated embodiment the tote 100 uses a zipper as the securing member 108 that extends along three sides of the lower containing unit 102. In embodiments where the lower containing unit 102 and upper containing unit 106 are manufactured of a rigid material the appropriate toggle latches, catchbolts, compression latches, etc. can be used.

The upper containing unit 106 is, in this example, a modified pyramid with its base aligning with the lower containing unit 102 and its top aligning with the handle unit 104. A securing member 110, in this illustration a zipper, extends along three (3) sides of the upper containing unit 106.

Both the upper containing unit 106 and the lower containing unit 102 are heavily insulated both from the external temperatures and from each other. The recommended insulation along the sides, bottom and top is a minimum of 7 mm of polyurethane foam insulation, or its equivalent. The area between the upper and lower compartments preferably has about 10 mm polyurethane foam, or its equivalent to minimize heat transfer between the upper containing unit 106 and the lower containing unit 102. The use of 10 mm polyurethane foam improved overall heat keeping in the lower compartment by about 10% over the 7 mm insulation, bringing the temperature of the headed substance, after six (6) hours, from 47° C. (116.6° F.) to about 50° C.-51° C., (122° F.-123.8° F.).

The handle portion 104 contains an opening 120 through which the tote bag 100 is lifted. The opening 120 is reinforced in some manner appropriate to the material of manufacture, for example a rigid closed shape grommet, PE board, or stitching. It is preferable that the handle unit 104 have some structural strength to prevent sagging. This can be accomplished by providing a rigid or semi rigid reinforcement panel between two exterior sheets forming the handle unit 104, a rigid ring around the opening 120, etc. Although an oval is illustrated in the example herein, any other polygon convenient for carrying can be used.

When the tote bag 100 is manufactured from a soft material, the handle unit 104 can be a continuation of the material, with or without an additional layer incorporated, and reinforced with stitching 122 along the edges. The stitching 122 can continue from the edge of the handle unit 104 to the upper containing unit 106 to the securing member 108. Depending on the method and material of manufacture the stitching 122 within the upper carrying unit 106 can be functional or decorative. In embodiments where the outer surface of the upper carrying unit 106 and the handle unit 104 are of a continuous material, a separating strip 124 can be used. The separating strip 124 serves to bring the sides of the upper containing unit 106 together to form the handle 104. The separating strip 124 can be stitching, glue, fusing or other methods appropriate to the material.

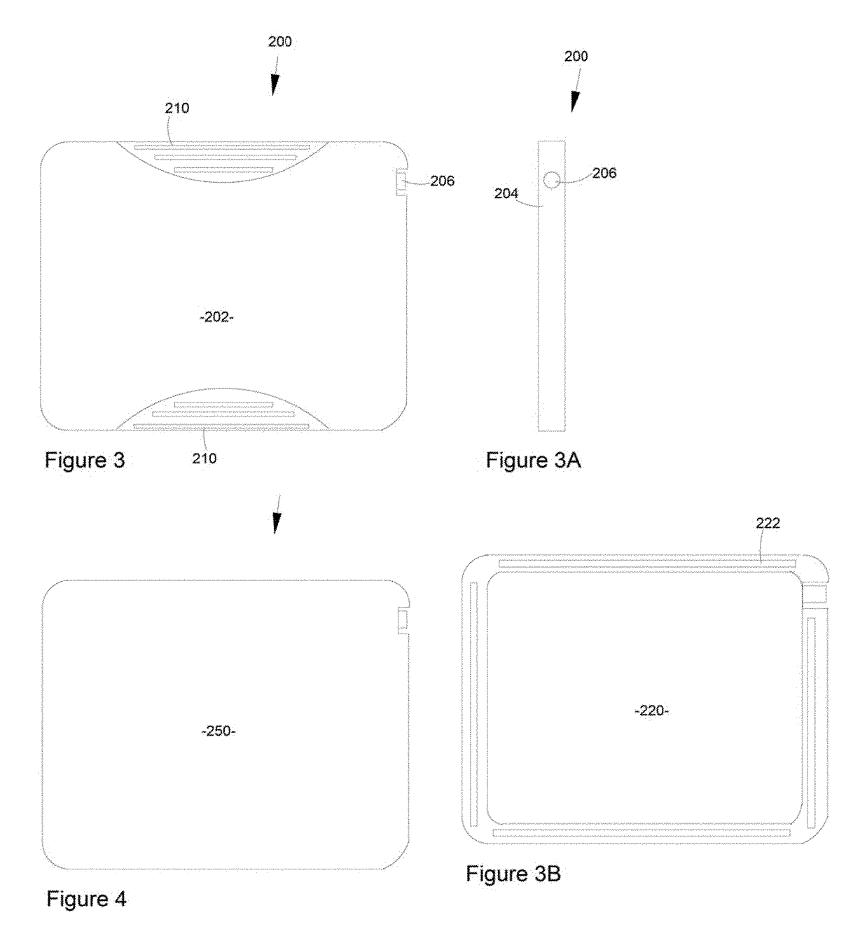

FIGS. 3 and 3A illustrate an example of the heating unit 200 for use within the above tote as well as any other appropriate container, whether or not it has been illustrated herein as an example. The dimensions are not critical to the heating unit 200, although for convenience the unit should fit within a microwave as that will be the most common method of heating. Additionally, the heat generated by the unit will be proportionate to the quantity of the phase change material within the unit 200.

The exterior of the preferred heating unit 200, is preferably a rigid polypropylene, or equivalent, shell 202, with a sealable fill port 206 on the side 204. The molding and fillable shell as illustrated is well known in the art and can be used with the disclosed phase change material. It is preferable that the heating unit 200 have gripping areas 210 that are not filled with phase change material in order for the heating unit 200 to be gripped without contacting the heated contents. As well known, microwaves only heat the food contained within a microwave safe container. These gripping areas 210 permit the user to safely handle the heating unit 200 without being burned. The gripping areas 210 are also preferably ribbed, or otherwise textured, to prevent slipping when being handled. The gripping areas 210 are easily formed when the heating unit 200 is being molded. Alternatively a ridge or ring of unfilled PP 222, or other material that will not absorb the heat, around the container 220, can be used, replacing the gripping areas 210 as illustrated in FIG. 3B. As an alternative, the heating unit 250 of FIG. 4 can be used without the gripping areas 210. Although microwave is the preferred heating method due to time and the ability to heat only the disclosed PCM, other methods of heating can be used dependent upon the material of manufacture of the container.

The hard shelled heating unit 200 can, in designs where it is fitted within the side of the carrier, provide additional structural rigidity. The material and manufacture of hard shells are well known in the art and any of the designs and materials that are safe for high temperatures can be used. One study on optimal shapes for heat units states “the geometric configuration and orientation with respect to gravity of the containers holding PCM affect the heat transfer mechanisms which play a significant role in evolution the shape, movement and morphology of solid-liquid interface and in turn affect the thermal characteristics of the melting process of PCM. The melting rate is higher in the upper portion of all containers where natural convection dominates. Therefore, increasing the height/width ratio of the enclosure for the same volume augments the buoyancy effect and results in expediting of the melting process and decreasing of the charging time” and “The computational results indicated that the rectangular container required nearly half of the melting time when compared to the cylindrical container of the same volume and heat transfer.” https://www.researchoate.net/ublication/272381946 Melting_and_convection_of_phase_change_materials_in_different_shape_containers_A_review

The disclosed phase change material can be used with a heat proof film bag, however the length of time for heat dispersal is not as long as the hard shelled polypropylene unit as the hard shell polypropylene also acts as a phase change material of sorts and absorbs, and then releases, some heat.

Further, when using a film pouch, typically the phase change materials is first pressed/molded into a shape similar to a bar of soap (somewhat cylindrical, with thicker areas in the center and thinner areas toward the edges). Reproducing this configuration in tests found this melts unevenly in the microwave, with the center melting completely and the edges remaining solid under finite heating times. In the rigid container, where its shape and height is held constant thereby encouraging natural convection, it melts more evenly.

To avoid the possibility of inadvertently puncturing the bag, it is recommended that soft poly bags be placed in a fabric pocket.

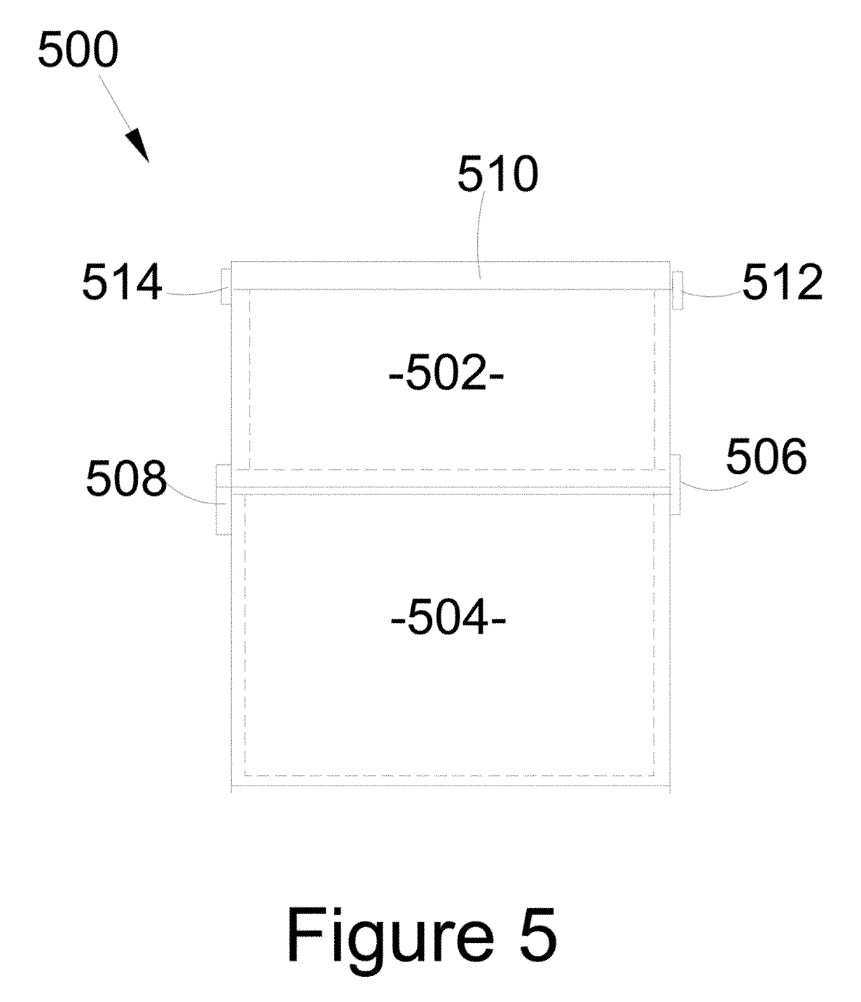

In FIG. 5 a hard shell carrier 500 is illustrated having a top unit 502 and bottom unit 504 connected by hinge 506. The top unit 502 and bottom unit 504 are maintained adjacent one another through an appropriate fastening member 508. The lid 510 rotates on hinge 512 and is maintained closed by a fastening member 514.

In this figure the placement of the insulation can more easily be seen. Depending upon the material of manufacture, the thickness and type of insulation can be changed and the appropriate insulation materials will be known to those in the art.

A pair of heating units can be placed on the bottom and top of the container to be kept warm or on the sides. Web, fabric of other material pockets can be added to totes to maintain the heating units in the preferred area. When the heating unit is used for clothing, specific pockets can be used to maintain the properly shaped units. For example, in ear muffs the heating units would be manufactured in circular discs that would fit within pockets provided within the ear muffs. When used for seats, such as stadium seats or bicycle seats, the heating unit would be specifically designed to accommodate the configuration of the receiving article. The altering of the shapes for various uses will be known to those skilled in the art.

Whether the heating unit is a hard shelled polypropylene unit 200, a flexible poly bag or any other material it must meet certain criteria. It must have the ability to withstand repeated high heat, microwavable, fluid proof, able to withstand impact, evenly radiate heat, and food compatible.

Although tests indicate that a thin, rectangular configuration is optimal, it should be noted that the disclosed phase change material will work with any configuration applicable for end use as noted heretofore.

The combination of properties provides the disclosed phase change material with characteristics ideally suited for use in food transportation, medical or other areas intended for commercial and/or consumer use where portability, higher temperatures, longer heat emissions and greater safety considerations are required.

The material disclosed herein is solid at ambient temperatures and liquefied at high temperatures. Heat can be absorbed or released when the phase change material changes from solid to liquid or vice versa. Thus, phase change materials can be classified as latent heat storage (LHS) units.

The disclosed PCM is a solid to liquid phase change material that can behave like sensible heat storage (SHS) materials—each material's temperature rises as they absorb heat. Unlike conventional SHSs, when phase change materials reach the temperature at which they change phase (their melting temperature) they absorb large amounts of heat at an almost constant temperature. Phase change materials can continue to absorb heat without a significant rise in temperature until all the material is transformed to the liquid phase. WIen the ambient temperature around a liquid material falls, the reverse holds true and the phase change materials can solidify, releasing its stored latent heat without a significant fall in temperature until all of the material is transformed into the solid phase.

Phase Change Temperature

A higher phase change temperature can ensure the safety or integrity of the phase change material for the intended use. A higher phase change temperature can allow the heat packs comprising phase change materials to remain solid at substantially higher temperatures.

The disclosed PCM is formulated to provide a higher phase change temperature with a broader spectrum phase change point. The addition of about 49%-59% palmitic acid (C16) and 51%-41% stearic acid (C18) fatty acids, and most preferably 54% C16 and 45% C18, to polyethylene glycol 8000 (PEG8000), the phase change temperature increases. The temperature rises from about 55° C. (131° F.) to about 60° C.-80° C. (140° F.-176° C.), preferably about 65° C.-75° C. (149° F.-167° C.), and most preferably about 70° C.-71° C. (158° F.-159.8° F.). Although phase change temperatures can be higher, the danger of a person being burned when handling increases. More important than temperature, the combination also increased the length of time in which the heating unit remained hot, slowing its solidifying time when used in the tote. Other fatty acids that have the same reactions as set forth herein as the C16 and C18 when combined with PEG8000, or its reactive equivalent, can be used.

The preferred formulation to provide the longest heat release in a 178 mm×122 mm×16 mm heating unit is 150 g PEG8000 and 50 g of a fatty acid combination comprising about 54% C16 and about 45% C18. The increase or decrease of quantities can easily be accomplished by maintaining the 3:1 ratio of PEG8000 to the fatty acid combination.

For optimum results the fatty acid combination should be within the range of ten percent (10%) of the following criteria, however the further from the formulation and ratios set forth herein the further from the optimal heat and time as achieved with the disclosed formulation. The preferred fatty acids ratios are:

C16: 54%

C18: 45%

Testing

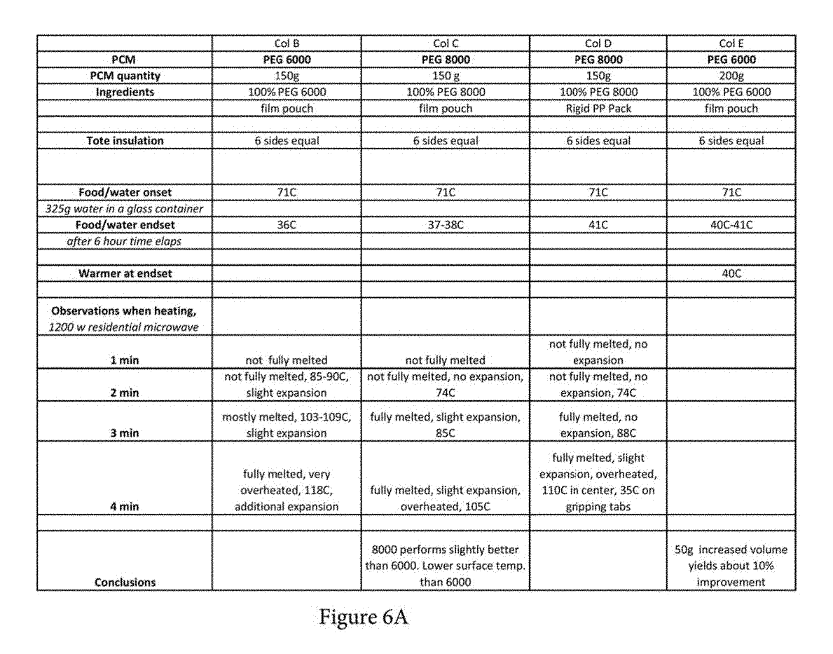

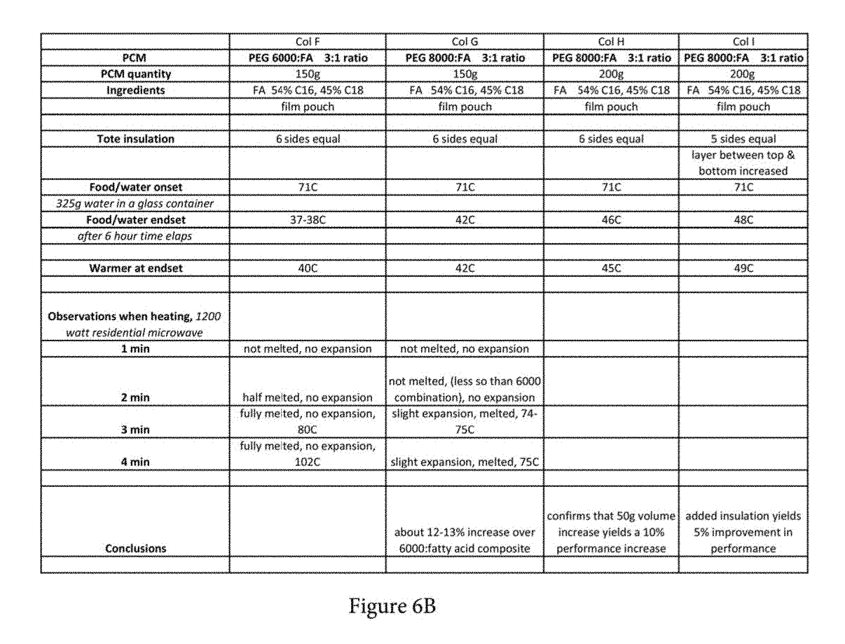

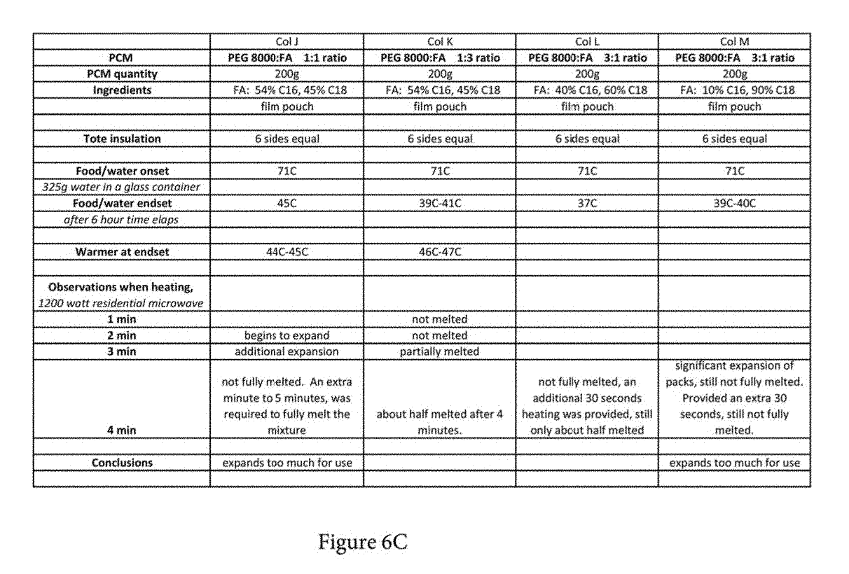

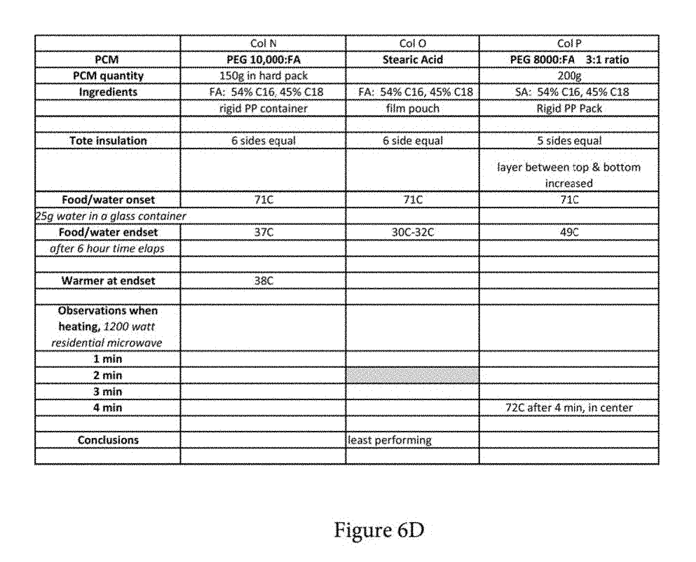

The variation range of the ratios and stearic acid formulation is narrow as was found by extensive testing. All tests below and illustrated in the charts of FIGS. 6A-D, unless otherwise noted, are using two (2) heat packs, each containing 150 g of PEG as a base material and heated until phase change occurred within a microwave. Except where indicated the material was heated for four (4) minutes, 1200 watt residential stopping the microwave after each one (1) minute interval to assess the quantity of material melted and any housing expansion. Results were determined through use of the heating unit within a tote. Unless noted otherwise, the insulation on the tote was of 7 mm of polyurethane foam equal thickness on all six (6) sides. When increased, the insulation was 10 mm polyurethane foam between the upper and lower compartments. The food (325 g water in a glass container) was heated to 71° C. (159.8° F.) and the two heating units heated for four (4) minutes. The two heating units and food were then placed in the tote as set forth heretofore. After six (6) hours the temperature of the food was measured.

The first step in the testing sequence was to determine whether PEG6000 or PEG8000 alone produced the best results.

Col. B—150 grams of PEG 6000, contained in a poly film pouch, were heated as set for above. After six (6) hours the food temperature had dropped from 71° C. (159.8° F.) to about 35° C. (95° F.).

After one (1) minute of heating the PEG had not melted, and no expansion of the housing was observed. At two (2) minutes, the PEG was partly melted, there was a slight expansion in the housing and the heating units reached a temperature of 85° C.-90° C. (185° F.-194° F.). At three (3) minutes the PEG was about 80% melted and there was a slight expansion in the packs, and they measure 103° C.-109° C. (217.4° F.-228.2° F.), which is far too hot for safety. At four (4) minutes, the PEG is fully melted and appears very overheated, measuring 118° C. (244.4° F.), with a more noticeable expansion of the packs.

Col. C—150 grams of PEG 8000 contained in a poly film pouch were heated as set for above. The food temperature had dropped from 71° C. (159.8° F.) to about 37° C.-38° C. (98.6° F.-100.4° F.). Subsequently 200 g of PEG was heated and after six (6) hours the food fell from 71° C. (159.8° F.) to 40° C. (104° F.). This represents a slight improvement over PEG 6000 of about 5% or less.

After one (1) minute of microwaving the PEG 8000 was not melted and there was no housing expansion. At two (2) minutes, the PEG was partially melted with no housing expansion and reached a temperature of 74° C. (165.2° F.). At three (3) minutes the PEG was fully melted, measured 85° C. (185° F.), with very slight housing expansion. At four (4) minutes, the PEG was fully melted and appeared overheated with a slight expansion of the packs which measure 105° C. (221° F.), an improvement over PEG 6000

Conclusion: PEG8000 performs slightly better than PEG6000 and has a lower surface temperature after heating than the PEG6000.

Col D—At this stage in the testing, 150 g of PEG 8000 was tested in a rigid polyethylene pack. At both one (1) minute and two (2) minutes of heating, the PEG8000 was not fully melted with no expansion in the container. At three (3) minutes the PEG8000 was fully melted, without container expansion, and had a temperatures of 88° C. (190.4° F.). At four (4) minutes the PEG8000 was fully melted, with a slight expansion, and was overheated at 110° C. (230° F.), in the center and 35° C. (95° F.) on the gripping tabs. The food was 71° C. (159.8° F.) at the onset and, after six (6) hours was 41° C. (105.8° F.).

Conclusion: The lesser quantity of PEG 8000 in the rigid container performed at the same level as a greater quantity of PEG 6000 demonstrating the improvement resulting from the rigid container.

Col. E—The quantity of PEG6000 was increased to 200 g and tested in a film pouch. The food, starting at 71° C. (159.8° F.), was at 40° C.-41° C. (104° F.-105.8° F.), at the end of six (6) hours and the heat unit was at 40° C. (104° F.).

Conclusion: The addition of 50 g PEG 6000 yielded about a 10% improvement. This is the same result as the lesser amount of PEG 8000 in a rigid container.

Col. F—150 g PEG 6000, and fatty acid combination consisting of 54% C16 and 45% C18 in a 3:1 ratio was contained in a poly film pouch. After two (2) minutes the contents were about half melted with no expansion observed, after three (3) minutes the contents measured 80° C. (176° F.), and were fully melted with no expansion observed, after four (4) minutes the combination was fully melted, measured 102° C. (215.6° F.), and had only slight expansion.

Conclusion: This temperature poses a significant burn risk. After six (6) hours, the heat unit measured 40° C. (104° F.) and the food went from 71° C. (159.8° F.) to 38° C. (100.4° F.), a 10% improvement over PEG 6000 alone.

Col. G—150 grams PEG 8000, fatty acid combination of 54% C16 and 45% C18, contained in a poly film pouch and heated as noted above.

In heating 150 g PEG 8000:fatty acid combination after two (2) minutes the contents were not melted and no expansion of the housing was observed, after three (3) minutes the contents was somewhat melted and measure 74° C. (165.2° F.), after four (4) minutes the contents measured 75° C. (167° F.) and were fully melted with a slight amount of expansion. After six (6) hours the 150 g warming elements themselves measure 42° C. (107.6° F.).

Conclusion: The food temperature fell from 71° C. (159.8° F.) to 42° C. (107.6° F.) after six (6) hours, representing about a 13% improvement over the same combination using PEG 6000 and PEG 8000 alone.

Col. H—An increase in the amount of PEG 8000: fatty acid combination, 3:1 ratio, from 150 g to 200 g further reduced the decrease in food temperature. The food fell from 71° C. (159.8° F.) to 46° C. (114.8° F.).

Conclusion: This confirms that 50 g volume increase yields a 10% performance increase.

Col. I—When the amount of insulation between the upper and lower compartments was increased, using the foregoing 200 g PCM PEG 8000:fatty acid combination, contained in a poly film pouch, it was found that the food payload temperature (325 g water in a glass container) fell from 71° C. (159.8° F.) to 48° C. (118.4° F.) over six (6) hours. The warming elements themselves measure 49° C. (120.2° F.).

Conclusion: The addition of insulation between the top and bottom compartments yields an additional 5% improvement in performance.

Col. J—200 grams of PEG 8000: fatty acid combination 54% C16, 45% C18, contained in a poly film pouch in a 1:1 ratio was heated as set forth above. The food temperature fell from 71° C. (159.8° F.) to 45° C. (113° F.) representing only slightly lower results to the 3:1 tests when comparing the food temperature after a six (6) hour period.

Conclusion: Upon heating the container expanded significantly to the point where bursting would be a concern rendering this solution both unsafe and not commercially viable

Col. K—200 g of PGE8000:fatty acid combination using a 1:3 ratio was heated with the food starting at 71° C. (159.8° F.) and dropping to 39° C.-41° C. (102.2° F.-105.8° F.) after six (6) hours with the heat unit dropping to 46° C.-47° C. (114.8° F.-116.6° F.).

When heating the heat unit, the phase change material did not melt for the first two (2) minutes. At three (3) minutes it was partially melted and only about one half of the 200 g was melted after four (4) minutes with the housing displaying significant expansion.

Conclusion: This represents lower results than the 3:1 and 1:1 ratios, and is impractical due to the extended heating time required and housing expansion. It was determined that in order to increase the melting speed a microwave receptor such as Carbon Black would need to be added to the mixture. In a second test 5 g of Carbon Black was added to the mixture and was contained in a poly pack. After only ninety (90) seconds in the microwave a burning smell was detected. At two (2) minutes in the microwave the test was terminated because the sizable hole was melted in the packs and the contents released.

Col L—In heating 200 grams PEG 8000 fatty acid combination of with a combination 40% C16 and 60% C18, the food temperature fell from 71° C. (159.8° F.) to 37° C. (98.6° F.) after six (6) hours, providing no improvement over 100% PEG. The variation in C16 and C18 quantities actually produced lower results than both 100% PEG 6000 & 100% PEG 8000.

Conclusion: This combination was only about half melted after four and a half (4.5) minutes and therefore unacceptable for use as disclosed.

Col M—200 grams PEG 8000 fatty acid combination of 10% C16 and 90% C18, the food temperature fell from 71° C. (159.8° F.) to 39° C.-40° C. (102.2° F.-104° F.) after six (6) hours. To achieve these results, the composite required microwaving for more than five (5) minutes, at which time the composite was still not fully melted. Moreover, upon microwaving it was observed that the packs displayed significant expansion, rendering them both at risk of bursting and not commercially viable. This same test was repeated two more times, with the addition of 3 grams of Carbon Black, and 5 grams of Carbon Black to the PEG8000:fatty acid combination.

Conclusion: Upon microwaving it was observed that the housing melted causing a hole in the housing after only two (2) minutes in the microwave. It is believed that the Carbon Black caused areas to heat too high too quickly, causing hot spots, which melted the housing.

Col. N—150 grams PEG 10,000, fatty acid combination 54% C16, 45% C18 In a ratio of 3:1 in a rigid PP pack.

After six (6) hours the food payload temperature fell from 71° C. (159.8° F.) to 37° C. (98.6° F.), representing no increase over PEG alone and a result about 10% less than PEG 8000:fatty acid combination.

Col. O—200 grams of only the fatty acid combination was tested as per above. The combination would not melt in the microwave by itself, and after five (5) minutes it was only about half melted, and the results were as if no heating element had been added at all the payload fell from 71° C. (159.8° F.) to 32° C. (89.6° F.).

Conclusion: The fatty acid combination alone represented the lowest results confirming the need to add PEG.

Col. P—The final configuration tested 200 g PCM PEG 8000:fatty acids combination in the rigid PP container, with increased insulation between the upper and lower compartments of the tote, and found the food payload temperature (325 g water in a glass container) fell from 71° C. (159.8° F.) to 50° C. (122° F.) over a six (6) hour period.

In heating 200 g PEG 8000:fatty acid combination in a 3:1 ratio, after four (4) minutes the packs measure 72° C. (161.6° F.) and had only a slight expansion. This is a safer handling temperature and can be handled with bare hands for short periods of time. When using 200 g PCM the heating elements measured 49° C. (120.2° F.) after six (6) hours which demonstrates the greater heat capacity of this configuration.

### CONCLUSIONS

As seen from the above data, when used alone the PEG 8000 performs nearly identical to PEG 6000. However, with the addition of the fatty acid combination, the results diverge. The PEG 8000 combination demonstrated a 10-15% improvement over the PEG 6000 combination; a 15-20% improvement over PEG 6000 alone, and about a 13% improvement over PEG 8000 alone.

The use of fatty acids was discussed in the article “Differential Scanning Calorimetry Study of Blends of Poly(ethylene glycol) with Selected Fatty Acids by Krzysztof Pielichowski of the Technical University in Krakow Poland. They tested stearic acid (gradel/quality unspecified) in combination with PEG 10,000 in varying ratios of PEG:SA of 3:1, 1:1 & 1:3. This study claims that adding Stearic Acid in a 1:3 ratio PEG:SA improves performance greatly (more than 30%). However, in the disclosed test results the opposite is shown. As the fatty acid combination increased, performance decreased and the 1:3 ratio demonstrated the lowest performance. Moreover the above article did not test PEG 8000, only PEG 10,000 and above.

In the disclosed testing, when the fatty acid combination is introduced the PEG 8000 performs better and the PEG 10,000 showed the lowest results of the three.

Looking at varying fatty acid combinations it was found that results decrease as C18 increases. The microwave time needed for phase change increased as well as C18 increased, to the point that it would not fully melt in the microwave with 90% C18 even with up to six (6) minutes in the microwave. At that point, Carbon Black needed to be added as a conductive agent, however when added the mixture gave off a gas which expanded the housing to a point that was both unsalable and dangerous; and created hot spots which melted the housing. Both are unacceptable due to the potential of bursting the housing and releasing off hot liquid.

1. Once the optimal combination, 3:1 PEG-fatty acid combination of C16:about 54%, C18:about 45% was determined, the mixture was tested in both a film pouch and a rigid polypropylene (PP) container. The PP container produced improved results over the film pouch and inherently provides substantially greater resistance to leaking and/or breaking than the pouch.

Both Stearic Acid and Palmitic acid (C16 & C18) are inexpensive, readily available and chemically benign and therefore is used in a number of items coming in contact with humans. Although in this use, the phase change material is contained, if by chance the enclosure is broken, the contents are benign.

To keep food warm, one or more heat units 200 are placed in an insulated carrier. Most commonly one heated unit 200 is placed on the bottom of the carrier with the food placed on top of the heat unit 200. A second heated unit 200 is placed on top of the carrier and the carrier closed.

When determined the number of heat units 200 to use to maintain the desired temperature of food, quantity, container and density of food need to be taken into consideration. The denser the food, the slower it cools. The foregoing tests were performed using water, which will have a faster cooling rate than even soup. Therefore, a meal, whether it is soup or lasagna, will remain warmer longer than the water tested.

### Broad Scope of the Invention

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims (e.g., including that to be later added) are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language of the present invention or inventions should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.”

While in the foregoing we have disclosed embodiments of the invention in considerable detail, it will understood by those skilled in the art that many of these details may be varied without departing from the spirit and scope of the invention.

What is claimed is:

1. A heat unit, said heat unit having an outer container, said outer container having at least two walls, containing a phase change material, said phase change material changing from solid to liquid at a temperature of about 60° C.-80° C. (140° F.-176° F.) upon exposure to a heat source for a predetermined period of time.

2. The heat unit of claim 1 wherein said phase change material consists of polyethylene glycol 8000 and a fatty acids combination of stearic acid and palmitic acid.

3. The heat unit of claim 2 wherein said stearic acid is in the range of 48%-59% and said palmitic acid is in the range of 51%-41%.

4. The heat unit of claim 2 wherein said fatty acid combination is preferably about 54% palmitic acid and about 45% stearic acid.

5. The heat unit of claim 2 wherein said ratio of polyethylene glycol 8000 to fatty acids combination is about 3:1.

6. The heat unit of claim 1 wherein said heat source is a microwave and said predetermined period of time is about four (4) minutes.

7. The heat unit of claim 2 wherein said temperature of said heat pack is about 40° C.-55° C. (104° F.-131° F.) after six (6) hours in an insulated container.

8. The heat unit of claim 7 wherein said insulated container is a food carrier.

9. The heated unit of claim 7 wherein said insulated container has insulation equivalent of at least 7 mm of polyurethane foam insulation.

10. The heat unit of claim 8 wherein food placed in said food container is at about 45° C.-50° C. (113° F.-122° F.) after about six (6) hours.

11. The heat unit of claim 1 wherein said container is a rigid polyethylene.

12. The heat unit of claim 1 wherein said phase change material has a latent heat capacity of at least about 190 kj/kg.

13. The heat unit of claim 11 wherein said container has gripping areas, said gripping areas being two of said at least two walls in contact with one another to prevent heat transfer from said phase change material to an exterior surface of said container.

14. A heating system, said heating system for a food carrier having:
at least one heat pack, said heat pack having at least two walls, each of said at least one heat pack containing:
a phase change material, said phase change material comprising:
about three parts polyethylene glycol 8000; and
about one part fatty acid combination, said fatty acid combination being stearic acid in the range of 48%-59% and said palmitic acid in the range of 51%-41%,
said phase change changing from solid to liquid and a temperature of about 65° C.-75° C. (149° F.-167° F.) upon being exposed to a heat source for about four (4) minutes with a latent heat capacity of about 190 kj/kg,
an insulated tote, said insulated tote capable of maintaining a temperature of a substance heated to about 71° C. (159.8° F.) placed in said insulated tote with said at least one heat pack of about 44° C.-49° C. (111.2° F.-120.2° F.) after six (6) hours.

15. The heat unit of claim 14 wherein said fatty acid combination is about 54% palmitic acid and about 45% stearic acid.

16. The heat unit of claim 14 wherein said heat source is a microwave and said predetermined period of time is about four (4) minutes.

17. The heat unit of claim 15 wherein said container is a rigid polyethylene.

18. The heat unit of claim 17 wherein said container has gripping areas, said gripping areas being two of said at least two walls in contact with one another to prevent heat transfer from said phase change material to an exterior surface of said container.

19. The heat unit of claim 2 wherein said fatty acid combination is preferably about 54% palmitic acid and about 45% stearic acid.

20. The method of maintaining a substance above a predetermined low temperature using an insulated container and at least one heat unit, each of said at least one heat unit containing a phase change material having 3 parts polyethylene glycol and 1 part fatty acid combination consisting of about 54% palmitic acid and about 45% stearic acid, comprising the steps of:
a. determining a predetermined low temperature;
b. heating said substance to a temperature above said predetermined low temperature;
c. heating said at least one heat unit for about four (4) minutes;
d. placing said substance in said insulated container;
e. placing said at least one heat unit adjacent to said substance;
f. securing said insulated container.
